(19) United States
(12) Patent Application Publication
(10) Pub. No.: US 2019/0325069 A1
(43) Pub. Date: Oct. 24, 2019

(54) IMPRESSION-TAILORED COMPUTER SEARCH RESULT PAGE VISUAL STRUCTURES

(71) Applicant: Microsoft Technology Licensing, LLC, Redmond, WA (US)

(72) Inventors: Saulo Santos, Lynnwood, WA (US); Manish Mittal, Redmond, WA (US); Abinash Sarangi, Redmond, WA (US); Prithvishankar Srinivasan, Seattle, WA (US); Hariharan Ragunathan, Bellevue, WA (US); Rahul Lal, Redmond, WA (US); Aman Singhal, Bellevue, WA (US); Marcelo Medeiros De Barros, Redmond, WA (US)

(73) Assignee: Microsoft Technology Licensing, LLC, Redmond, WA (US)

(21) Appl. No.: 15/956,307

(22) Filed: Apr. 18, 2018

(51) Int. Cl. G06F 17/30; G06K 9/62; G06F 15/18

(52) U.S. Cl. CPC G06F 17/30867; G06F 15/18; G06K 9/6282; G06F 17/30905

(57) ABSTRACT

A search engine query can be received, along with contextual data encoding information about a context of the query. The query can be classified into a selected user interface profile of multiple available user interface profiles, with the classifying including applying a classification model to the contextual data. A visual structure generator can be selected using results of the classifying, and a search results page can be generated for the query. The generating of the search results page can include using the selected visual structure generator to impose a selected visual structure on the search results page, with the selected visual structure corresponding to the selected visual structure generator. The generated search results page can be returned in response to the receiving of the query.

### BACKGROUND

Web search engines have had a somewhat rigid visual user interface where the variations in search results pages that include the results of searches are driven primarily by different data coming from the backend systems. For example, local rich answers may show up in the results set of a web search engine depending on the query and the location where the user query is coming from, which may change the overall results shown on the page, but the underlying visual structure remains unchanged. Web search engines often run experiments, where a set of users in an experiment may experience user interface changes compared to other users. However, the users who fall into the same experiment will get the same underlying visual structure of the search results page being displayed.

### SUMMARY

The tools and techniques discussed herein relate to tailoring visual structures of search result pages to corresponding individual impressions. As used herein, an impression is a set of computer-readable data regarding an individual query, which includes contextual data that encodes conditions in which the query was issued, such as temporal data, platform data, network data, and/or other contextual data. The impression can also include data encoding the individual query itself, such as the text of the query. By tailoring the visual structures to individual impressions, different visual structures can be provided that are more efficient for user interface actions that are expected to be taken in response to the search results for the corresponding individual queries. This can yield a more efficient computer search user interface, which can be more efficient for the user and can make more efficient use of computer resources.

In one example aspect, the tools and techniques can include receiving a user-input computer-readable query, with the query requesting search results from a computerized search engine. An impression comprising contextual data can be received. The contextual data can be connected to the query in the computer system, with the contextual data encoding information about a context of the query. The query can be classified into a selected user interface profile of multiple available user interface profiles, with the classifying including applying the classification model to the contextual data. In response to the receiving of the query, a visual structure generator can be selected out of multiple available visual structure generators, with the selecting using results of the classifying of the query. The available visual structure generators can include different visual structure generators that are each programmed to impose a different visual structure to displayable search results pages. Also, in response to the receiving of the query, a search results page can be generated, with the search results page including at least a portion of the requested search results. The generating of the search results page can include using the selected visual structure generator to impose a selected visual structure on the search results page, with the selected visual structure corresponding to the selected visual structure generator. The generated search results page can be returned in response to the receiving of the query.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is schematic diagram of a search result page visual structure tailoring computer system.

FIG. 3 is an illustration of a search results page with a default visual structure.

FIG. 4 is an illustration of a search results page with a reading visual structure.

FIG. 5 is an illustration of a search results page with a non-scrolling visual structure.

FIG. 6 is an illustration of a search results page with a browsing visual structure.

FIG. 7 is an illustration of a search results page with a competitor visual structure.

FIG. 8 is a flowchart illustrating a technique for impression-tailored computer search result page visual structures.

### DETAILED DESCRIPTION

Aspects described herein are directed to techniques and tools for more efficient search engine user interfaces that are tailored to impressions for corresponding individual queries using contextual data for such queries. Such improvements may result from the use of various techniques and tools separately or in combination.

Such techniques and tools may include adapting the search user interface to the context of the individual query. The tools and techniques may include machine learning features that can facilitate machine learning by a computer system of “hidden” aspects of how users interact with the search engine's user interface. Based on those aspects, the tools and techniques can include classifying contextual data, which corresponds to an impression for an individual user query. For example, that contextual data may encode a specific time for the query, an identifier of a specific device from which the query is received, an identifier of a specific application such as a browser application from which the query is received, and/or other data. The computer system can classify this contextual data into a pre-defined profile. Following are examples of such profiles: Profile 1: a non-scrollable profile, where the computer system has some degree of confidence user input will not scroll down the page of search results; Profile 2: a reader profile, where the computer system has some degree of confidence that more time will be spent “reading” the page, i.e., viewing the page without clicking on links on the page; Profile 3: a competitor profile, where the computer system has some degree of confidence user input will be provided to navigate from the search engine page to another search engine; and Profile 4: a browsing profile, where the computer system has some degree of confidence user input will click on many links on the page, and click back to the page.

Visual structure generators can take actions in the computer system and can be associated with profiles. A visual structure generator is a mechanism that can be used to customize the user interface, such as to maximize a “user's engagement” depending on the profile onto which the model fit the user query's contextual data. Respectively as to the above profiles, following are some examples of actions that may be taken by the different visual structure generators: For profile 1 above, take the action of suppressing user interface elements below the fold (i.e., below the area of the page that is initially visible on the display) in case of a mobile device, hence saving network bytes/rendering time and maximizing user interface engagement above the fold. For profile 2 above, take the action of increasing the font size of titles (e.g., by 2 pixels), and/or improving the contrast of the captions for the web results compared to the background color by making the font color slightly darker for such captions. For profile 3 above, visually highlight some of the unique characteristics of the search engine, such as rewards points, for example by increasing contrast compared to a background color and/or increasing the size of such characteristics. For profile 4 above, enhance some exploratory features by increasing clickable area for links and/or otherwise changing the user interface slightly to make features more prominent, such as related searches, titles, spacing, and/or also-try features.

The model to be used can be any of various different computerized classification models. For example, the classification model can be a machine learning model, such as one or more decision trees, such as a single decision tree or a random forest, or an artificial neural network such as a deep neural network The machine learning models may be supervised models where labeled data for training the models comes from search engine log data, which may include contextual data for queries, as well as data indicating user interface actions that followed receipt of search results. For example, the logs may be logs that do not include personally identifiable information for user profiles submitting the queries.

By tailoring the user interface structure of the search results to impressions for individual queries using a classification model to select and use an appropriate user interface visual structure generator, the tools and techniques can provide search result user interfaces that are more efficient for users and for the computer system itself. For example, the available computer display screen area can be utilized more effectively for the type of user interface actions that are likely to occur in response to receiving the search results page. Additionally, user interface actions such as browsing, or reading can be done more quickly with a user interface structure that is tailored to such actions, decreasing the amount of electrical power required for actions (e.g., by decreasing the amount of time that a computer display must be on for such actions to be accomplished). For example, this may result from a user interface structure being tailored to a browsing user interface profile or a reading user interface profile, where such actions can be performed more quickly with the appropriate user interface structure. The tailored user interface structures can also decrease mistakes in user input (due to misreading text in the search results or due to selecting the wrong link, for example), which can reduce wasted processor usage, memory usage, and computer network usage. Moreover, tailored user interface structures can also reduce the sending of wasted data items as part of the user interface that will likely not be utilized in particular contextual situations—such as where there is some degree of confidence that search results located below the fold will not be viewed because no scrolling user input would be provided. Moreover, these benefits and others can increase the usability of the search results user interface, with user interface structure being tailored to the impression for the individual query.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

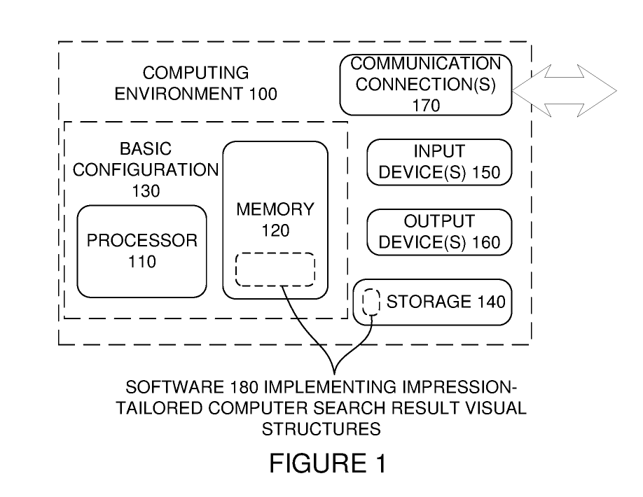

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

As used herein, a user profile is a set of data that represents an entity such as a user, a group of users, a computing resource, etc. When references are made herein to a user profile performing actions (sending, receiving, etc.), those actions are considered to be performed by a user profile if they are performed by computer components in an environment where the user profile is active (such as where the user profile is logged into an environment and that environment controls the performance of the actions). Often such actions by or for a user profile are also performed by or for a user corresponding to the user profile. For example, this may be the case where a user profile is logged in and active in a computer application and/or a computing device that is performing actions for the user profile on behalf of a corresponding user. To provide some specific examples, this usage of terminology related to user profiles applies with references to a user profile providing user input, sending queries, receiving responses, or otherwise interacting with computer components discussed herein. User profiles can be distinguished from the user interface profiles discussed above, which can be used to classify the individual queries.

In utilizing the tools and techniques discussed herein, privacy and security of information can be protected. This may include allowing opt-in and/or opt-out techniques for securing users' permission to utilize data that may be associated with them, and otherwise protecting users' privacy. Additionally, security of data can be protected, such as by encrypting data at rest and/or in transit across computer networks and requiring authenticated access by appropriate and approved personnel to sensitive data. Other techniques for protecting the security and privacy of data may also be used.

### I. Exemplary Computing Environment

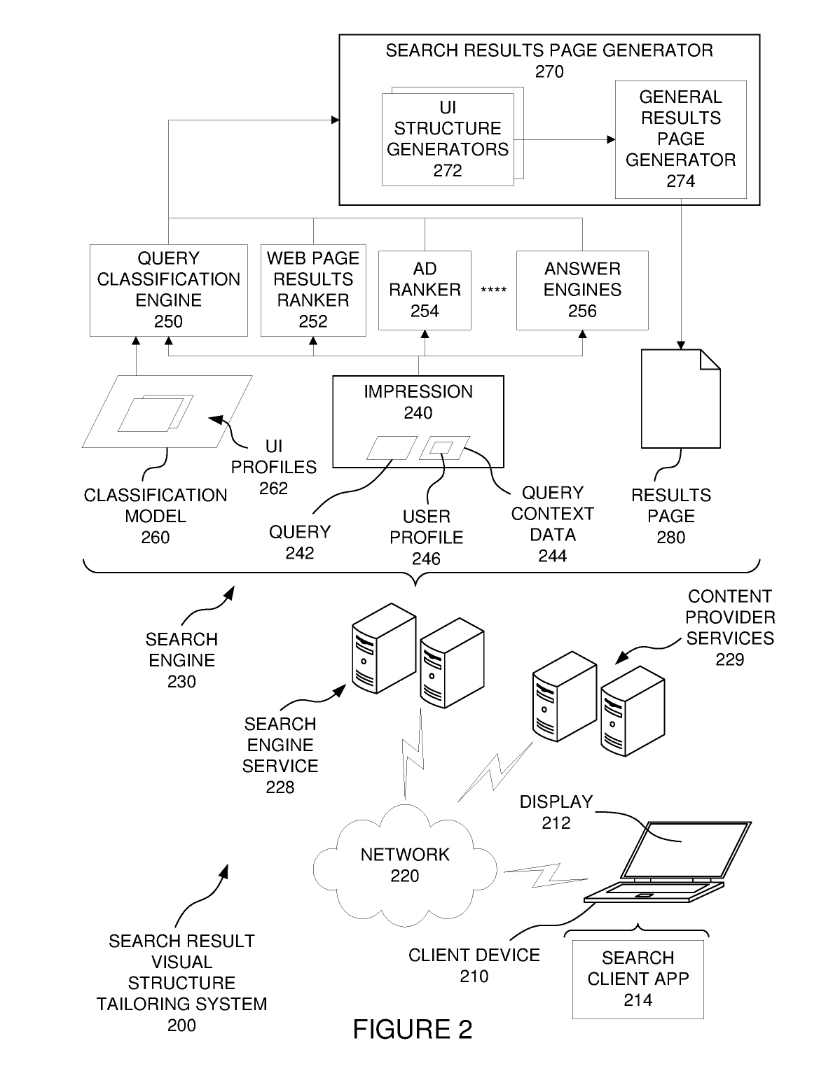

FIG. 1 illustrates a generalized example of a suitable computing environment (100) in which one or more of the described aspects may be implemented. For example, one or more such computing environments can be used in the system discussed below with reference to FIG. 2, such as a client device or as at least part of a search engine service. Generally, various computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing impression-tailored computer search result page visual structures. An implementation of impression-tailored computer search result page visual structures may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The memory (120) can include storage (140) (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level descriptions for operations performed by a computer and should not be confused with acts performed by a human being, unless performance of an act by a human being (such as a “user”) is explicitly noted. The actual computer operations corresponding to these terms vary depending on the implementation.

### II. Impression-Tailored Computer Search Result Visual Structures System

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

Referring now to FIG. 2, components of a search result page visual structure tailoring computer system (200) will be discussed. Each of the components includes hardware, and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

The system (200) can include a client device (210), which can include a visual computer display (212). The system (200) can also host a search client application (214), which can receive user input to request computer queries (such as user queries for Web sites) and can receive and display results of the searches on the computer display (212). The client device (210) can communicate through a computer network (220) with a search engine service (228), and may also communicate with other services, such as content provider services (229) that provide content referenced by the search results. For example, a search results page may include links that can be selected by user input to trigger the client device (210) to retrieve content (e.g., Web pages) referenced by the links on the search results page, from the content provider services (229).

The search engine service (228) can host a search engine (230), which can include multiple computer components that work together to respond to user queries (queries entered as user input into a computing device) received from client devices, such as the client device (210). For example, the search engine (230) can include a query classification engine (250), which is discussed more below. The search engine (230) can also include a Web page results ranker (252), which can rank indexed result items that link to Web pages, with the ranking being indicative of a score based on various factors, so that the result items can be ordered in the search results according to the rankings. The search engine (230) can also include an advertisement ranker (254), which can rank available digital advertisements for inclusion with the main Web page search result items. The search engine (230) can also include one or more answer engines (256), which can provide direct answers to questions posed in a query received from the client device (210). The search engine (230) may include other components, or plug-ins, which can provide other different types of items in response to the queries.

The processing components (250, 252, 254, and 256) discussed here can each receive at least part of an impression (240), which is computer-readable data that provides information about an individual query just received from the client device (210). For example, the impression (240) can include the query (242) itself (which may be in the same form as received from the client device (210) or in some other form, such as a translation of the query, etc.). The impression (240) can also include contextual data or query context data (244). The query context data (244) is data other than the query (242) itself, but which encodes information about the context in which the query was entered or received. The processing components (250, 252, 254, and 256) can all receive the same impression (240), or they may receive different portions of the impression (240), depending on what data is useful in the processing to be done by each component. Some of the query context data (244) can be received from the client device (210), and some may be received from other computing devices, such as from other components in the search engine service (228) or other computing components in the system (200). Either way, the query context data (244) can be considered to be received along with the query (242) if it is received at the time of entry of the corresponding query in the client device (210) or thereafter. However, some of the query context data (244) may have already been present in the search engine (230) or in some other computer service, but may be provided in response to the query (242). As an example, a user profile (246) may be logged in at the client device (210) in connection with the submission of the query (242), so that the query (242) is considered to be received from the user profile (246). In this case, the query context data (244) may include at least a portion of the user profile (246), which may include indications of past actions of the user profile (246) in response to receiving search results and/or user preferences explicitly entered into the user profile (246) by user input.

The query classification engine (250) can also access a classification model (260), which can be encoded with user interface profiles (262). Specifically, the query classification engine (250) can use the classification model (260) to classify an individual query (242) into one of the user interface profiles (262). The classification model (260) and classification engine (250) can take any of multiple different forms.

Where the classification model (260) is to be trained using machine learning techniques, an existing machine learning toolkit can be used. Such a toolkit can define one or more types of machine learning models, allowing administrative users to provide user input to define hyperparameters for the classification model (260). The classification model (260) can then be trained using training data, such as historical search engine logs that define contextual features surrounding individual queries submitted to a search engine, and that define corresponding user interface actions taken in response to receiving the search results for the queries.

As an example, the classification model (260) can be a decision tree that is trained using machine learning techniques. In one implementation, an existing decision tree model from a toolkit can be used. User input can be provided to define hyperparameters, such as how many nodes and how many leaves are included in the decision tree, and/or other hyperparameters, such as a maximum depth of the decision tree. User input can also define the inputs to the decision tree, which can include features from the query context data (244). The inputs may also include features from the query (242) itself (keywords, categories of types of searches derived from the text of the query (242) itself, etc.). Also, administrator user input can define the user interface profiles (262) into which sets of query inputs are to be classified. When using the classification model (260) to process the impression (240), categorical data can be converted to numerical data for processing. For example, if the impression (240) to be processed includes labels for cities, the names of the cities can be converted into corresponding numbers. As another example, yes/no categories may be converted into a value of zero for one answer and a value of one for the other answer. Accordingly, the appropriate impression (240) for a query (242) can be converted to a vector of numerical values, and that vector can be processed by the classification model (260).

The classification model (260) can be trained in the search engine service (228), but it may be trained in a development environment outside the search engine service (228) and later transmitted to the search engine service (228). As an example, for a decision tree, the computer system can define an attribute test for each of the nodes in the decision tree. Such an attribute test may utilize one or more of the inputs. For example, if one of the inputs has a value of zero for a weekday and a value of one for a weekend, one node may simply test whether the query context data (244) includes a value of zero or one for that input. The decision tree could include two branches leading from such a node—one for the value of zero and one for the value of one. As another example, that weekend/weekday input may be combined with time of day in a single attribute test. For example, this test may determine whether the time of the query was between midnight and 8:00 AM (8:00) on a weekday, between 8:00 AM (8:00) and 5:00 PM (17:00) on a weekday, between 5:00 PM (17:00) and midnight on a weekday, between midnight and 6:00 PM (18:00) on a weekend, or between 6:00 PM (18:00) and midnight on a weekend. The decision tree may include branches leading from the node for each of these time/day ranges.

The computer system (200) can use one or more of different techniques to define the nodes and leaves of the decision tree. As an example, the system (200) may use histogram-based techniques, which can bucketize continuous feature (attribute) values into discrete bins. The decision tree growth technique may use different ordering techniques to grow the decision tree, such as invoking level-wise tree growth (defining one level of the tree at a time, starting with the root node) or leaf-wise tree growth (choosing a best leaf to grow first, such as a leaf with a maximum difference (maximum delta loss), followed by the next-best leaf, etc.).

In a trained decision tree, the leaves can each correspond to a confidence value for each of one or more user interface profiles (262). When training the decision tree, the computer system (200) can utilize search engine logs, such as a month of search engine logs from a major search engine. For each query in the logs, the training technique can process the corresponding inputs from the query context data (244) using the tests defined for the nodes of the decision tree. Upon arriving at a leaf of the decision tree with the processing, the computer system can identify which of the user interface profiles (262) applies for that query and can update the model accordingly. For example, this can include adjusting weights in the model, to reduce differences between the type(s) of user interface profile(s) (262) indicated by the results of applying the model, and what user interface actions are recorded in the search engine logs for that query.

While the above description is with regard to a decision tree, other types of classification models (260) may be used. For example, a random forest of decision trees may be used. A random forest can be utilized similarly to the decision tree discussed above, except that a random forest can include multiple trees with different characteristics (e.g., with different hyperparameters for different trees, such as different numbers of nodes), and different portions of the training data may be run through different ones of the decision trees. In some situations, random forests may be better that single decision trees at generalizing results and incorporating more disparate training data into the model. As another possibility, the classification model (260) may be some other type of machine learning model, such as a deep neural network. Such a model may be trained using deep neural network training techniques, such as adjusting model parameter weights using backpropagation, etc.

Following are some examples of query context data (244) that may be processed using the classification model (260): platform data, such as a network address for a client device from which the query is received, an application identifier for an application from which the query is received, a geographic location identifier (e.g., one or more of a city, state, country, a latitude value, a longitude value, etc.), a device type identifier that identifies a type of device from which the query is received, a screen size identifier that identifies a display screen size of a device from which the query is received; and temporal data, such as a time identifier that identifies a time of day for the query, a day identifier that identifies a day for the query (e.g., a specific day of the week, or whether the day is a weekday or a weekend). As another example of such input features, one feature may be whether the search engine (230) provides an answer in a top position in a search results page in response to the query. For example, an answer can be a search engine directly answering a question posed in the query, rather than just providing links to search results (e.g., providing stock quotes or making mathematical computations in response to identifying queries requesting such answers). Some other examples may include network data, such as an indication of the speed of the network connection of the client device (210), and/or an indication of whether the client device (210) has a metered network connection. The query context data (244) may include combinations of such types of contextual data and/or other types of contextual data.

As discussed above, during training, the computer system (200) can correlate the input data, such as the input data noted above, with output data. The output data can be data indicating user interface actions taken in response to receiving search results for a corresponding query (242). The system (200) can define features (values, thresholds, labels, etc.) of such output data that can be indicative of a particular user interface profile (262). For example, scroll distance (how much a search results page is scrolled in one or more directions in response to user input), length of each scroll, number of scrolls in each of one or more directions, amount of time to first click a link on a page (in seconds), how many times user input clicks on a link on the search results page and then returns to the search results page, and whether user input requests navigation from the search results page to a page for requesting searches from a different search engine. The system may define threshold values for such output data, where the system can take exceeding a threshold as indicative of a corresponding user interface profile (262). For example, scrolling for less than a threshold number of pixels (such as less than ten pixels, which can include not scrolling at all) may be indicative of a non-scrolling user interface profile (262). Also, having at least a threshold number of seconds until the first click on a search results page may be indicative of a reading user profile. Also, clicking on a link on the search results page and then returning to the search results page more than a threshold number of times can indicate a browsing user interface profile (262). As another example, where the output value is a categorical value, user input requesting navigation from the search results page to a page for requesting searches from a different search engine can be indicative of a competitor user interface profile (262). In training, such indications can be taken as indicating the presence of the corresponding user interface profile (262).

After the classification model (260) is trained, it can be used by the query classification engine (250) to classify individual queries (242) in real time. Also, the classification model (260) may be further trained using additional search engine logs including impressions (240) and data indicating user interface actions taken in response to search results from corresponding individual queries.

Referring still to FIG. 2, when responding to a query (242), the query classification engine (250) can select a user interface profile (262) based on the results of processing the impression (240) using the classification model (260). Specifically, the classification engine (250) can determine which, if any, of the user interface profiles (262) applies to the query (242). For example, the query classification engine (250) may determine whether any of the resulting confidence scores exceeds a threshold value. For example, the processing of the classification model (260) may indicate a reading profile with a confidence score of 0.7, and a non-scrolling profile with a confidence score of 0.3. The query classification engine may be programmed to only select a user interface profile (262) if it has a score greater than a threshold value of 0.6. Thus, the query classification engine (250) may determine that the query (242) is classified into the reading profile. The query classification engine (250) can transmit its results to a search results page generator (270). For example, the query classification engine (250) may transmit a computer-readable indicator of which, if any, user interface profile(s) (262) the query (242) is classified as. The search results page generator (270) can receive the results of the classification from the query classification engine (250), along with data from other query processing components (252, 254, and 256). Specifically, for the results of the classification, the search results page generator (270) can include user interface structure generators (272) for each of multiple available user interface profiles (262). A search results page generator (270) can be selected using the classification of the query (242) into a user interface profile (262). For example, this selection may compare confidence values for one or more user interface profiles (262) to one or more computer-readable thresholds or and/or rules. For example, a user interface structure generator (272) may be selected if a confidence score for the corresponding user interface profile is above a threshold value.

As an example, the user interface structure generators (272) may include user interface libraries that define user interface structural changes to be applied for corresponding user interface profiles (262). For example, these may include changes such as those discussed above for a non-scrollable profile, a reader profile, a competitor profile, a browser profile, or some combination of changes from such profiles. The results from the selected user interface structure generator(s) (272) can be provided to a general results page generator (274). The general results page generator (274) can also receive data from the other query processing components (252, 254, and 256), indicating data such as ranked results lists, advertising item lists, and query answers to be included in a search results page (280) produced by the general results page generator (274). The selected user interface structure generator(s) (272) can impose the corresponding user interface structure changes corresponding to one or more of the selected user interface profile(s) (262) on the search results page (280) by indicating such changes to the general results page generator (274), which can be programmed to implement the user interface structure changes indicated by the selected user interface structure generator(s) (272). This can be done without changing the content of the search results, such as the Web page results list, the advertisements, or the answers provided by the respective query processing components (252, 254, and 256) in the search engine (230).

The search results page (280) that includes the user interface structures imposed by the selected user interface structure generator(s) (272) can be returned to the client device (210) via the computer network (220). The client device (210) can display the search results page (280) on the computer display (212), and can receive user input directed at user interface features of the search results page (280), such as user input selecting links on the search results page, user input scrolling the search results page (280), etc.

While the search result visual structure tailoring system (200) has been described with reference to particular features, such as data structures, operational components and devices, many other different configurations of different features may be utilized to carry out the features defined in the claims below. For example, rather than a machine-learning model, the classification model (260) may be a non-machine learning rule-based model, which can be encoded with rules that are applied to the impression (240) to classify a corresponding query (242) into one or more corresponding user interface profiles (262).

### III. Examples of Impression-Tailored Computer Search Result Page Visual Structures

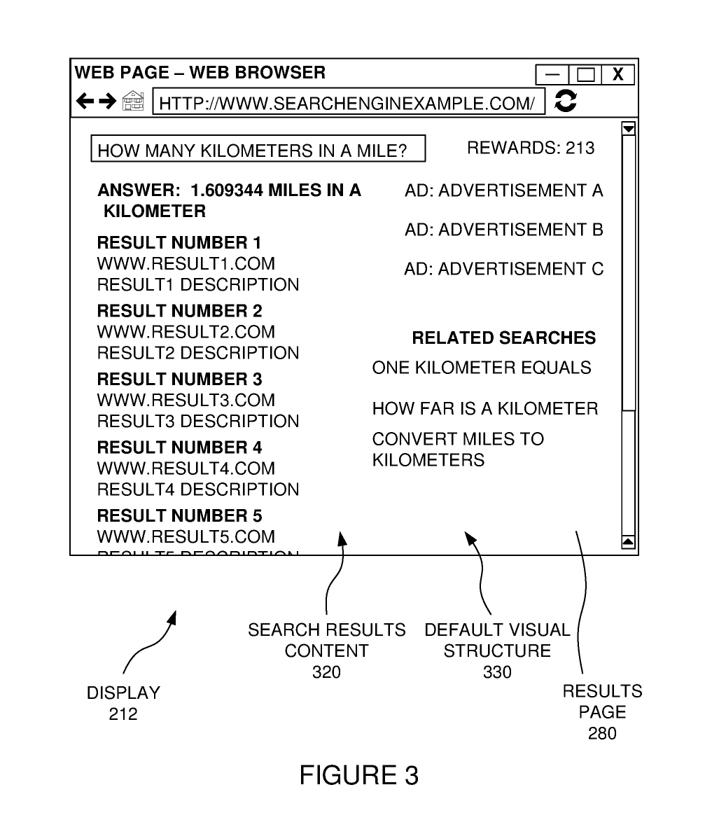

Examples of a search results page (280) with a default visual structure, and with different visual structures imposed on it, will now be discussed with reference to FIGS. 3-7. Referring first to FIG. 3, a search results page (280) displayed on a computer display (212) with a default visual structure (330) is illustrated. The search results page (280) shows a portion of the search results content (320). The search results page (280) includes a scroll bar on the right side. It also includes a query text entry box for entering text queries. The text in the box currently states, “HOW MANY KILOMETERS IN A MILE?”, and the search results page (280) includes an answer for the query as a top result in a left column of the page, stating “ANSWER: 1.609344 MILES IN A KILOMETER.” Under the answer is a list of Web page search results, each including a title (e.g., “RESULT NUMBER 1”) that can be a link. If the link is selected, the computer system can respond by retrieving and displaying the content referenced by the link. Similarly, the search results page (280) can include advertisements (e.g., “AD: ADVERTISEMENT A”), and related searches. The advertisements and the related searches can be links, which can be selected to retrieve a page referenced by an advertisement or send a query listed in the related searches to the search engine. The search results page (280) may not include some of these types of search results content (320), and it may include other types of search results content (320).

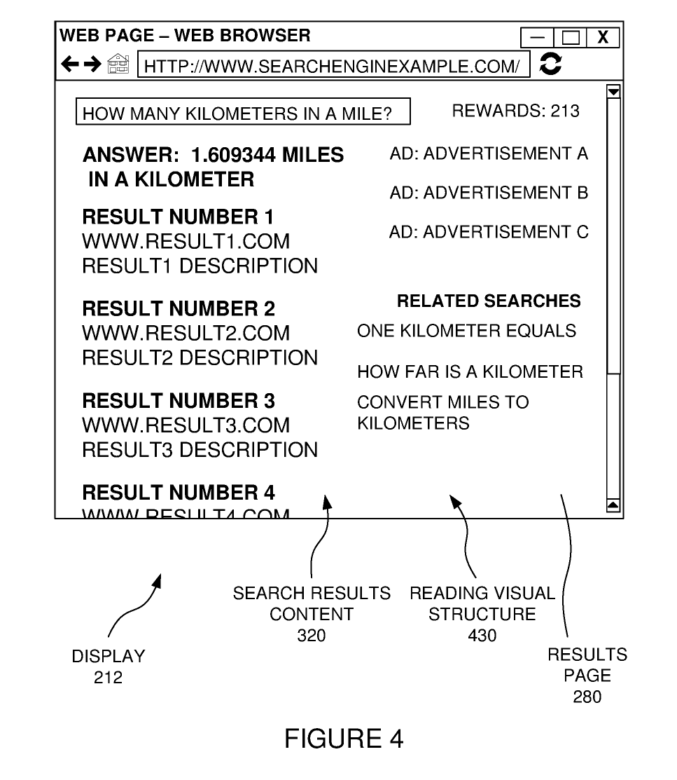

FIGS. 4-7 illustrate the same search results content (320) in a search results page (280), but with different visual structures imposed on the search results page (280). FIG. 4 illustrates the search results page (280) with a reading visual structure (430) imposed on the page. This can include increasing a font size for the answer and the list of Web page search results. It can also include increasing the spacing between different listings in the list of Web page search results. Such changes can make it easier and more efficient for a user to read the answer and the list of Web page search results.

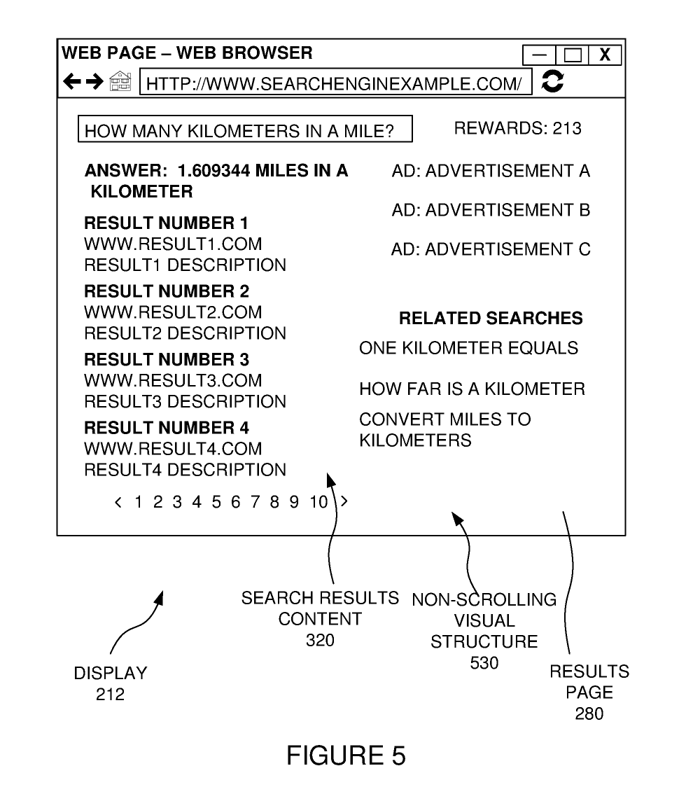

FIG. 5 illustrates the search results page (280) with a non-scrolling visual structure (530). The non-scrolling visual structure (530) can include moving content that would have been below the fold to another page, such as to a second page of the search results. As illustrated in FIG. 5, the search results page can omit such content, and it can omit a scroll bar or other visual scrolling features. The bottom of the page can include a navigation feature for navigating to other pages of search results, which can include numbers and arrows that can act as links to other search results pages with additional search results content (“<1 2 3 4 5 6 7 8 9 10>”). As discussed above, this non-scrolling visual structure (530) can allow the search engine to send less content for the first page, which can result in faster loading times and less use of processors, memory, and computer network bandwidth. It can also result in a cleaner user interface (without scrolling features), which can be advantageous for users in situations where scrolling is not to be done. Note that while some content may be moved to other search results pages for this non-scrolling visual structure (530), the search results content (320) remains the same.

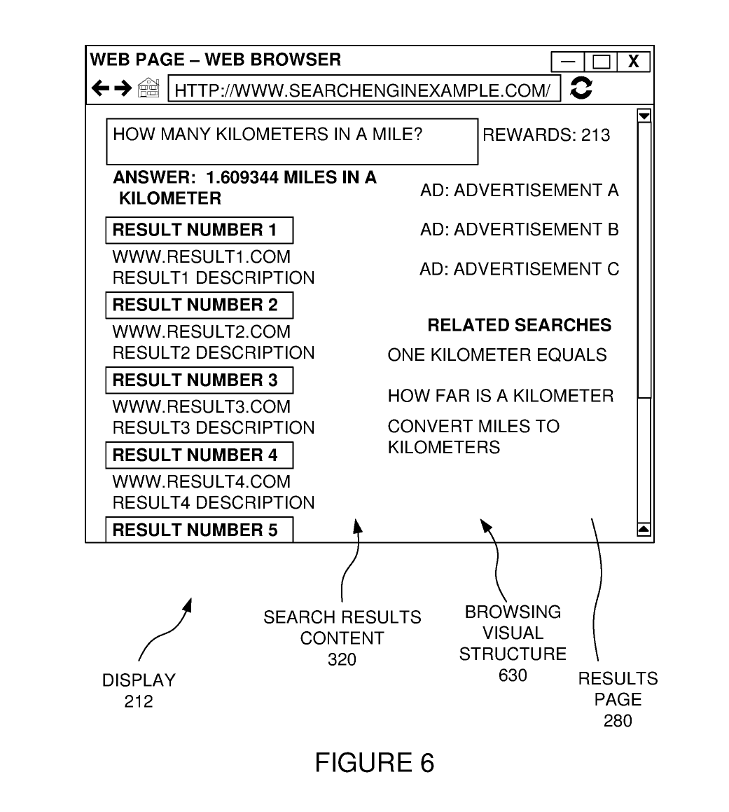

Referring to FIG. 6, the search results page (280) is illustrated with a browsing visual structure (630). The browsing visual structure (630) can make clicking on links in the search results easier and less error prone. For example, as shown, each listing in the Web page search results can include an increased clickable area for clicking on the link and may also include a box around the text of the title for the listing, to form a displayed button. For example, a clickable button may include the title “RESULT NUMBER 1”, as shown in FIG. 6.

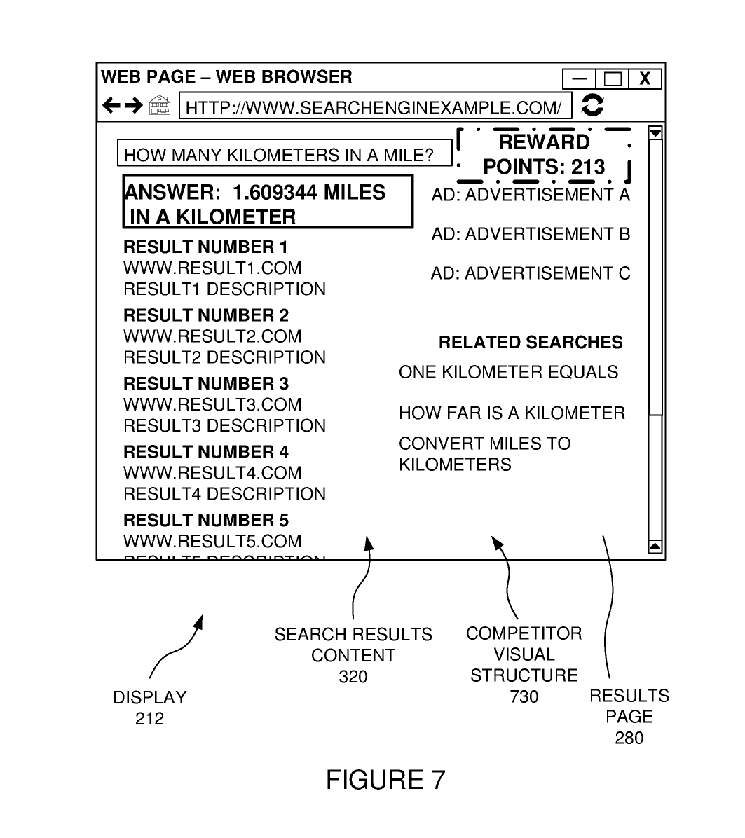

FIG. 7 illustrates the search results page (280) with a competitor visual structure (730). The competitor visual structure (730) can include visual structure changes that can highlight features of the search results page (280) that may be advantageous, as compared to one or more competing search engines. For example, the search results page (280) indicates how many rewards points a corresponding user profile has earned in a rewards program with the search engine. These rewards points may be highlighted in some manner, such as by increasing the font size, changing the color, or including a border or highlighted background for this feature. As another example, the answer may be highlighted in some manner, such as by including a border that is not otherwise present for the answer, as shown in FIG. 7.

While examples of visual structures with particular changes are illustrated in FIGS. 4-7, other different features and/or other different types of visual structures corresponding to other types of user interface profiles may be utilized in accordance with the teachings set forth herein.

### IV. Techniques for Impression-Tailored Search Results Visual Structures

Techniques for impression-tailored search results visual structures will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic. Features discussed in each of the techniques below may be combined with each other in any combination not precluded by the discussion herein, including combining features from a technique discussed with reference to one figure in a technique discussed with reference to a different figure. Also, a computer system may include means for performing each of the acts discussed in the context of these techniques, in different combinations.

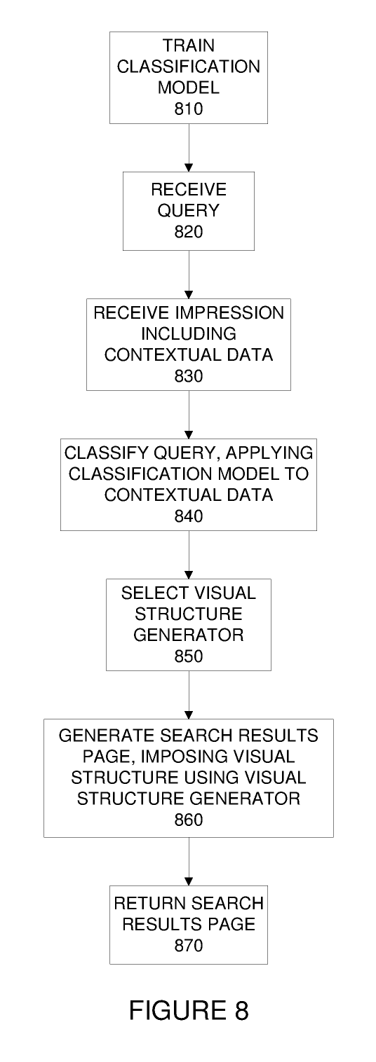

Referring to FIG. 8, a technique for impression-tailored search results visual structures will be described. The technique can optionally include training (810) a computer-readable machine learning classification model to classify queries into user interface profiles, with the training (810) using training data from a plurality of queries. The training data can include contextual training data from the queries and may also include corresponding user interface response training data from the queries. A user-input computer-readable query can be received (820), with the query requesting search results from a computerized search engine. The technique can also include receiving an impression including contextual data (830), which can be connected to the query in the computer system, with the contextual data encoding information about a context of the query. The technique can include classifying (840) the query into a selected user interface profile of multiple available user interface profiles, with the classifying including applying the classification model to the contextual data. The technique can also include responding to the receiving (820) of the query by selecting (850) a visual structure generator out of multiple available visual structure generators, with the selecting (850) using results of the classifying (840) of the query. The available visual structure generators can include different visual structure generators that are each programmed to impose a different visual structure to displayable search results pages. For example, such visual structure generators can include one or more user interface libraries as well as components that are programmed to use the user interface libraries to impose corresponding visual structures on displayable search results pages, such as hypertext markup language pages or other types of search results pages. The technique can also include responding to the receiving (820) of the query by generating (860) a search results page including at least a portion of the requested search results. The generating (860) of the search results page can include using the selected visual structure generator to impose a selected visual structure on the search results page, with the selected visual structure corresponding to the selected visual structure generator. The technique can further include returning (870) the generated search results page in response to the receiving (820) of the query. The technique may further include displaying the returned search results page and receiving user input directed at the search results page.

In the technique of FIG. 8, the query can be received from a user profile, and the contextual data connected to the query can include data specific to the user profile, such as data indicating past responses of the user profile to receiving search results, data indicating user preference settings for the user profile, and/or other types of data specific to the user profile. As one example, the contextual data connected to the query can be based at least in part on data collected from the user profile's past interaction with past search results from the search engine.

The contextual data connected to the query can include a data item selected from a group consisting of a network address for a client device from which the query is received, an application identifier for an application from which the query is received, a geographic location identifier, a device type identifier that identifies a type of device from which the query is received, a screen size identifier that identifies a display screen size of a device from which the query is received, a time identifier that identifies a time of day for the query, a day identifier that identifies a day for the query, and combinations thereof.

The classification model may be one of different types of machine learning models, such as a decision tree, a random forest, or a deep neural network. In other embodiments, the classification model may not be trained (810) by the computer system but may be a rule-based model that is not a machine learning model, but that invokes a set of classification rules. Such a non-machine learning model can be prepared with user input from developer users, which can define the rules for the model, while a machine learning model can be prepared by having user input define parameters and having the model be trained or tuned with machine learning techniques, as discussed above.

The using of the selected visual structure generator to impose the selected visual structure on the search results page can be performed without changing content of the search results, though this may include moving some search results content to other pages. Also, in some scenarios, content of the search results may be changed along with imposing the visual structure on the search results page.

The using of the selected visual structure generator to impose the selected visual structure on the search results page can include imposing a visual feature on a set of multiple search results in the search results page. For example, this may include changing a feature of the font for multiple different search results, as illustrated in the reading visual structure (430) of FIG. 4 above. Also, more specifically, the using of the selected visual structure generator to impose the selected visual structure on the search results page can include changing a visual feature of the search results page from what it would have been if the selected visual structure had not been imposed on the search results page. For example, the changing of the visual feature can include a changing action selected from a group consisting of: changing a font size, changing a font color, changing a background color, changing spacing between visual elements, omitting a scrolling feature, enlarging a visual element, and combinations thereof.

The search engine may be a first search engine, and the selected profile may be a reading profile that indicates a tendency toward greater time spent reading the results, a non-scrolling profile that indicates a tendency toward not scrolling the search results, a link browsing profile that indicates a tendency toward greater numbers of clicked links on the search results page, a competitor profile that indicates a tendency toward switching from the first search engine to a second search engine, or a combination thereof.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system comprising:
at least one processor; and
memory comprising instructions stored thereon that when executed by at least one processor cause at least one processor to perform acts of tailoring visual structures of search results pages to query context, with the acts comprising:
training a computer-readable machine learning classification model to classify queries into user interface profiles, with the training using training data from a plurality of queries, with the training data comprising contextual training data from the queries and corresponding user interface response training data from the queries;
receiving a user-input computer-readable query requesting search results from a computerized search engine;
receiving an impression comprising contextual data connected to the query in the computer system, with the contextual data encoding information about a context of the query;
classifying the query into a selected user interface profile of multiple available user interface profiles, with the classifying comprising applying the classification model to the contextual data;
in response to the receiving of the query, selecting a selected visual structure generator out of multiple available visual structure generators, with the selecting using results of the classifying of the query, and with the available visual structure generators comprising different visual structure generators that are each programmed to impose a different visual structure to displayable search results pages;
in response to the receiving of the query, generating a search results page comprising at least a portion of the requested search results, with the generating of the search results page comprising using the selected visual structure generator to impose a selected visual structure on the search results page, with the selected visual structure corresponding to the selected visual structure generator; and
returning the generated search results page in response to the receiving of the query.

2. The computer system of claim 1, wherein the query is received from a user profile, and wherein the contextual data connected to the query comprises data specific to the user profile.

3. The computer system of claim 2, wherein the contextual data connected to the query is based at least in part on data collected from the user profile's past interaction with past search results from the search engine.

4. The computer system of claim 1, wherein the contextual data connected to the query comprises a data item selected from a group consisting of a network address for a client device from which the query is received, an application identifier for an application from which the query is received, a geographic location identifier, a device type identifier that identifies a type of device from which the query is received, a screen size identifier that identifies a display screen size of a device from which the query is received, a time identifier that identifies a time of day for the query, a day identifier that identifies a day for the query, and combinations thereof.

5. The computer system of claim 1, wherein the classification model comprises a decision tree.

6. The computer system of claim 1, wherein the using of the selected visual structure generator to impose the selected visual structure on the search results page is performed without changing content of the search results.

7. The computer system of claim 1, wherein the using of the selected visual structure generator to impose the selected visual structure on the search results page comprises imposing a visual feature on a set of multiple search results in the search results page.

8. The computer system of claim 1, wherein the using of the selected visual structure generator to impose the selected visual structure on the search results page comprises changing a visual feature of the search results page from what it would have been if the selected visual structure had not been imposed on the search results page.

9. The computer system of claim 8, wherein the changing of the visual feature comprises a changing action selected from a group consisting of: changing a font size, changing a font color, changing a background color, changing spacing between visual elements, omitting a scrolling feature, enlarging a visual element, and combinations thereof.

10. The computer system of claim 1, wherein the search engine is a first search engine, and wherein the selected user interface profile is a reading profile that indicates a tendency toward greater time spent reading the results, a non-scrolling profile that indicates a tendency toward not scrolling the search results, a link browsing profile that indicates a tendency toward greater numbers of clicked links on the search results page, a competitor profile that indicates a tendency toward switching from the first search engine to a second search engine, or a combination thereof.

11. A computer-implemented method, comprising:
receiving, via a computer system, a computer-readable query requesting search results from a computerized search engine;
receiving, via the computer system, an impression comprising contextual data connected to the query in the computer system, with the contextual data encoding information about a context of the query;
classifying, via the computer system, the query into a selected user interface profile of multiple available user interface profiles, with the classifying comprising applying a computer-readable classification model to the contextual data;
in response to the receiving of the query, selecting, via the computer system, a selected visual structure generator out of multiple available visual structure generators using results of the classifying of the query, with the available visual structure generators comprising different visual structure generators that are each programmed to impose a different visual structure to displayable search results pages;
in response to the receiving of the query, generating, via the computer system, a search results page comprising at least a portion of the requested search results, with the generating of the search results page comprising using the selected visual structure generator to impose a selected visual structure on the search results page, with the selected visual structure corresponding to the selected visual structure generator; and
returning the generated search results page via the computer system in response to the receiving of the query.

12. The method of claim 11, wherein the classification model is a machine learning model.

13. The method of claim 11, wherein the classification model is a rule-based model that invokes a set of classification rules.

14. The method of claim 11, wherein the contextual data connected to the query comprises a data item selected from a group consisting of a network address for a client device from which the query is received, an application identifier for an application from which the query is received, a geographic location identifier, a device type identifier that identifies a type of device from which the query is received, a screen size identifier that identifies a display screen size of a device from which the query is received, a time identifier that identifies a time of day for the query, a day identifier that identifies a day for the query, and combinations thereof.

15. The method of claim 11, wherein the using of the selected visual structure generator to impose the selected visual structure on the search results page is performed without changing content of the search results.

16. The method of claim 11, wherein the using of the selected visual structure generator to impose the selected visual structure on the search results page comprises imposing a visual feature on a set of multiple search results in the search results page.

17. The method of claim 11, wherein the using of the selected visual structure generator to impose the selected visual structure on the search results page comprises changing a visual feature of the search results page from what it would have been if the selected visual structure had not been imposed on the search results page.

18. The method of claim 17, wherein the changing of the visual feature comprises a changing action selected from a group consisting of: changing a font size, changing a font color, changing a background color, changing spacing between visual elements, omitting a scrolling feature, enlarging a visual element, and combinations thereof.

19. The method of claim 11, wherein the search engine is a first search engine, and wherein the selected user interface profile is a reading profile that indicates a tendency toward greater time spent reading the results, a non-scrolling profile that indicates a tendency toward not scrolling the search results, a link browsing profile that indicates a tendency toward greater numbers of clicked links on the search results page, a competitor profile that indicates a tendency toward switching from the first search engine to a second search engine, or a combination thereof.

20. One or more computer-readable memory having computer-executable instructions embodied thereon that, when executed by at least one processor, cause at least one processor to perform acts comprising:
receiving a computer-readable query requesting search results from a computerized search engine;
receiving an impression comprising contextual data connected to the query in a computer system, with the contextual data encoding information about a context of the query;
classifying the query into a selected user interface profile of multiple available user interface profiles, with the classifying comprising applying a computer-readable machine learning classification model to the contextual data;
in response to the receiving of the query, selecting a selected visual structure generator out of multiple available visual structure generators using results of the classifying of the query, with the available visual structure generators comprising different visual structure generators that are each programmed to impose a different visual structure to displayable search results pages;
in response to the receiving of the query, generating a search results page comprising at least a portion of the requested search results, with the generating of the search results page comprising using the selected visual structure generator to impose a selected visual structure on the search results page, with the selected visual structure corresponding to the selected visual structure generator; and
returning the generated search results page in response to the receiving of the query.
